(19) United States
(12) Patent Application Publication
(10) Pub. No.: US 2014/0314256 A1
(43) Pub. Date: Oct. 23, 2014

(54) METHOD AND SYSTEM FOR MODIFYING A SOUND FIELD AT SPECIFIED POSITIONS WITHIN A GIVEN LISTENING SPACE

(71) Applicants: Lawrence R. Fincham, Santa Rosa, CA (US); Peter Brown, Kent (GB)

(72) Inventors: Lawrence R. Fincham, Santa Rosa, CA (US); Peter Brown, Kent (GB)

(21) Appl. No.: 14/205,131

(22) Filed: Mar. 11, 2014

Related U.S. Application Data
(60) Provisional application No. 61/800,566, filed on Mar. 15, 2013.

(51) Int. Cl. H04S 7/00

(52) U.S. Cl. CPC H04S 7/307; H04S 7/302
USPC 381/303

(57) ABSTRACT

An audio system provides modified audio signals for acoustic output sources (speakers) disposed around a listening area. A sound allocation processor receives an audio source signal. A plurality of audio modifying elements, each of which may comprise one or more custom filters, operate separately on the audio source signal and provide a custom output signal for each acoustic output source. The audio modifying elements may modify a gain and/or a phase characteristic of the audio source signal independently for each acoustic output source in order to create a substantially uniform sound level or desired sound field pattern over the listening area or within defined zones within the listening area. A global equalization adjustment may also be applied. Search algorithms may be used to arrive at appropriate parameters for the audio modifying elements.

### RELATED APPLICATION INFORMATION

This application claims the benefit of U.S. Provisional Application Ser. No. 61/800,566, filed on Mar. 15, 2013, hereby incorporated by reference as if set forth fully herein.

### BACKGROUND OF THE INVENTION

1. Field of the Invention

The field of the invention pertains to sound reproduction systems and, more specifically, methods and systems for modifying audio signals from two or more sound sources creating a sound field within a bounded or semi-bounded listening space to achieve a desired sound field distribution between and within specified listening positions.

2. Background of Related Art

Audio systems are commonplace in households, automobiles and other environments. Often, audio system components such as amplifiers and speakers are selected for certain desired characteristics such as high sound fidelity. However, the audio system components are only one factor affecting sound quality in a particular environment. Other factors include, among other things, the listening environment itself, the number and location of speakers, and the position of the listener.

For example, while many rooms are rectangular, usually one dimension (length or width) is longer than the other, meaning that sound unfolds differently across the different dimensions of the room and may reflect at different times off different walls. This effect is more pronounced with rooms that are not perfectly rectangular in shape. In addition, the presence of openings or doorways in a room can affect the way in which sound is reflected or re-directed. Semi-bounded rooms or spaces, such as an outdoor stage, may have only one or two walls and hence quite asymmetric characteristics for sound reproduction. Also, the presence of objects or physical features within the room or listening space, or the existence of surfaces of different types (e.g., windows or hard surfaces as compared to upholstery or soft surfaces) along the same or different walls, may also impact the way in which sound unfolds or is reflected within the area.

In addition to the particular characteristics of the listening area, the listener's position within the room or listening space also influences the audio experience and determines the quality and characteristics of the sound experienced by the listener. For example, it is known that modes may exist within a room or other bounded area at wavelengths generally comparable to the dimensions of the length or width of the room or area. These modes may cause constructive or destructive interference that and hence create acoustic suppression at certain specific frequencies related to the size (or shape) of the room or other area. These modes are hard to predict for non-rectangular rooms or areas with odd shapes or physical obstructions. The number and placement of speakers will also affect what a listener experiences at a particular location in the listening space. Speakers closer to a listening position will generally be louder than speakers farther away, and thus, at different listening positions, the aggregate effect of multiple speakers may differ quite dramatically. Certain speakers, such as dipoles, also have a directional component, and hence the relative orientation of the listening position as to the speakers can, in some cases, also affect the listener's experience.

The above issues may manifest as a detectable difference in power level over one or more frequencies or frequency bands as between different listening positions within a prescribed listening area. Where such variability in power level exists, the audio system may be viewed as inefficient or wasteful, among other things, because maximum power is experienced in fewer than all listening positions.

An example of a bounded listening area presenting particular challenges is the enclosed space within an automobile or other vehicle where the listening positions are predetermined and suitable locations for the low frequency drivers are restricted. In addition, the listening positions are restricted to the seating positions provided (usually 4 or 5) and all of these are very asymmetrically placed with respect to the speaker positions. Space is always at a premium within a car interior and as a result the speakers are often placed in physically convenient positions that are nevertheless often very poor from an acoustic point of view, such as the foot wells and the bottom of the front and rear side doors.

Some features are provided in automobile audio systems, or other sound systems, which can partially mitigate the aforementioned problems for one listening position but at the detriment of another. For example, an occupant can manually adjust the sound balance to increase the proportional volume to the left or right speakers. Some automobile audio systems have a “driver mode” button which makes the sound optimal for the driver. However, because different listening axes exist for left and right occupants or listeners, an adjustment to the balance that satisfies an occupant (e.g., driver) on one side of the listening area will usually make the sound worse for the occupant seated on the other side of the listening area. Moreover, balance adjustment requires manual adjustment by one of the occupants or listeners, and it is generally desirable to minimize user intervention. Various types of equalization may also be used, but these are typically global in nature and hence do not adequately address the different experience at different listening locations. In addition, a global equalization may improve the sound quality or experience at one location, but be detrimental to the sound quality or experience at other locations in the listening space.

Other techniques propose moving speakers around to find optimal speaker locations, but those techniques are not effective when speaker locations are fixed.

Similar asymmetries in sound experience and other related problems may occur in any other partially or wholly bounded listening space as well, such as in household rooms, auditoriums, arenas, and other defined listening areas. In some cases there is flexibility with respect to listening positions, but often the listening positions are generally fixed. Similarly, it is often the case that speaker locations are fixed and hence moving speakers is not an option.

In some cases, as opposed to the goal of having similar sound quality and level at the listening positions in a particular listening area, it may be desirable to provide different listening experiences for different occupants or listeners. For example, it may be desirable to have a quiet zone for one or more occupants, while maintaining good sound quality for the remaining occupants.

Accordingly, it would be advantageous to provide an improved sound system which overcomes one or more of the foregoing problems or shortcomings, and which can provide improved sound quality or selected sound field variability

### SUMMARY

Embodiments of the invention may include, in one aspect, a technique for sound allocation within a prescribed listening area, such as an semi-bounded or bounded listening space. The sound allocation technique may be employed to minimize variance in frequency response or audio level at different listening positions whilst optionally also obtaining maximum output capability, or alternatively may be employed to achieve a desired sound level pattern or sound field variability while optionally obtaining maximum power output. The sound allocation technique may also be used to achieve particular zones of generally uniform frequency response (i.e., transfer functions) or audio level at a specified listening position.

In a first aspect, an audio system with predefined speaker locations may be configured to achieve maximum or optimal power output with minimum variance (within a selected tolerance, for instance) at the listening positions.

In another separate aspect, an audio system with predefined speaker locations may be configured to achieve maximum or optimal power output when producing a desired sound level pattern or sound field variance.

In yet another separate aspect, an audio system with predefined speaker or acoustic output source locations may be configured to produce zones of uniform frequency response or audio level within a prescribed listening space, such as a bounded or semi-bounded listening area.

According to one or more embodiments as disclosed herein, an audio system with predefined acoustic output source (e.g., speaker) locations includes a sound allocation processor that modifies the signal sent to each speaker so that the vector sum of the all of the sound sources gives desired response characteristics at each listening position. The technique is generally applicable to any type of speakers, whether directional or not, and including monopole or dipole speakers for example.

Further embodiments, variations and enhancements are also disclosed herein

### BRIEF DESCRIPTION OF THE DRAWINGS

FIG. 1 is a diagram of an embodiment of a sound allocation system in accordance with one embodiment as disclosed herein.

FIG. 2 is a flow diagram illustrating a process for sound allocation in accordance with one example as described herein.

FIG. 3 is a top diagram illustrating an example of sound measurement locations for determining the sound reproduction characteristics of a listening area relative to different listening locations.

FIG. 4 illustrates a possible implementation of a sound allocation processor as may be used in connection with a sound allocation system in accordance with one or more embodiments as disclosed herein.

FIG. 5 is a conceptual diagram showing how the aggregate modified speaker outputs combine at each listening position within a listening area to generate a modified sound field or frequency response at each listening position, according to one example.

FIG. 6 is a diagram illustrating a bounded listening area with a set of speakers, and various graphs illustrating examples of sound measurements taken at specified listening positions in the listening area.

FIG. 7 is a diagram illustrating the same listening area as in FIG. 6, but with sound allocation as provided according to an example herein, and accompanying graphs showing modified audio characteristics or frequency responses at each of the same listening positions after the modified sound signals are played through the various speakers.

### DETAILED DESCRIPTION OF PREFERRED EMBODIMENTS

According to one or more aspects of embodiments disclosed herein, an audio system is provided having a plurality of acoustic output sources disposed in or around a listening area, with a sound allocation processor receiving an audio source signal. The sound allocation processor may include a plurality of audio modifying elements, one for each acoustic output source, modifying certain characteristics (e.g., a gain and/or a phase) of the audio source signal with respect to frequency for each acoustic output source to, for example, create a uniform sound level over the listening area or within defined zones within the listening area. The sound allocation processor may, in certain circumstances, be configured to maximize or optimize the output capability the acoustic output sources whilst at the same time minimizing the inter-seat response variability and the in-band response uniformity, within a selected tolerance.

In various embodiments, each of the audio modifying elements may comprise one or more custom filters for each acoustic output source, and may optionally further include a custom gain stage for each acoustic output source. The audio modifying elements may, for example, include a delay and/or non-minimum phase shift adjustment that is specifically tailored for each speaker or sound source. In addition, the sound allocation processor may comprise a global equalization adjustment applied to the audio source signal for all of the acoustic output sources.

In a preferred embodiment, the acoustic output sources include low frequency drive units, and the sound allocation processor is configured to affect primarily low frequencies of the audio source signal.

In another separate aspect, a method for sound allocation in an audio system is provided, comprising receiving an audio source signal and, for each of a plurality of acoustic output sources, independently modifying a gain and/or a phase of the audio source signal with respect to frequency to create a substantially uniform sound level or a desired sound field variability over the listening area or within defined zones within the listening area. The modified audio source signals are then conveyed to each respective acoustic output source.

According to another separate aspect, a method for sound modification in an audio system having a plurality of acoustic output sources in or around a prescribed listening area, comprises the steps of characterizing a sound transfer function for each of the acoustic output sources, and employing an annealing algorithm to identify parameters providing a specified sound level variance at defined listening positions within the listening area. The identified parameters may be durably stored in the audio system for future use, and may later be utilized in the audio system to modify an audio source signal so as to achieve the specified sound level variance within the listening area.

In certain embodiments, the identified parameters are applied to adjust a gain and/or a phase of different spectral components independently for each of the acoustic output sources. One or more custom filters as well as a custom gain for each acoustic output source may be used to independently modify the audio source signal for that acoustic output source. The identified parameters may include a speaker-specific delay and/or a non-minimum phase shift as applied separately and independently to each speaker or sound source.

In a preferred embodiment, as explained in greater detail herein, the annealing algorithm may involve selecting candidate sound modification parameters for each acoustic output sources, applying the sound modification parameters to determine a sound output level at the defined listening positions within the listening area; and determining a variance in sound output level between the different listening positions. If the variance in sound output is within a specified tolerance, the candidate sound modification parameters may be accepted. The sound modification parameters may include a selected gain associated with each acoustic output source, and/or a selected phase for different spectral components associated with each acoustic output source. For example, the selected phase adjustment may involve a frequency-dependent phase pattern using a component providing a non-minimum phase shift.

According to certain embodiments, a sound allocation technique is provided that may maximize or optimize the output capability in an audio system. The sound allocation technique may also or alternatively, for example, minimize sound variation among different listening positions, within a selected tolerance, or produce a desired sound level pattern or sound field variability. The sound allocation technique may also be used to create “relatively quiet spots” or “relatively quiet zones” and/or produce zones of uniform frequency response or audio level within a prescribed listening space. These quiet zones may have a specified sound level reduction as compared to other areas of the prescribed listening space. Conversely, the sound allocation processor may be used to create zones of relatively boosted sound or volume level, having a specified sound level increase as compared to other areas of the listening space.

The sound allocation techniques and related embodiments described herein may find particularly advantageous use for listening spaces in which the wavelength at the maximum frequency of interest subject to processing are greater than 1/10^{th} of the maximum dimension of the listening space. For example, for an automobile interior as the listening area, it may be desirable to perform the disclosed sound processing on frequencies in and below the neighborhood of 200 Hertz, which corresponds to wavelengths in the range of roughly 5-6 feet. In other embodiments, such as for residential rooms of ordinary size, the sound processing may be performed primarily in the low frequency range, below some selected threshold such as below 400 Hertz, below 250 Hertz, or 150 Hertz. Conversely, for smaller enclosed spaces, such as a telephone booth for example, the sound processing may be performed over a larger or higher frequency range, such as up to 1 kHz or 2 kHz for instance.

In an embodiment in which level allocation is applied by an audio sound system, a set of four low frequency drive units at predefined locations within an enclosed listening space are provided with processed audio signals in order to provide near constant sound levels across frequencies or a desired sound field variability at different listing positions within the enclosed space.

Although one or more preferred embodiments are described having four low frequency drive units, it is to be understood that such a configuration is merely exemplary. Embodiments of the invention can be practiced with a fewer number (e.g., two or three) low frequency drive units, or a greater number, or with other types of sound sources having characteristics of a monopole, dipole or combination thereof as well of any arbitrary number so long as the number of speakers is sufficient to create the desired sound level pattern or sound field variability. The sound allocation is preferably performed over non-directional frequency bands such as the frequency band below 200 Hertz; thus, the speakers or other sound sources are optimally, but need not be, low frequency drive units.

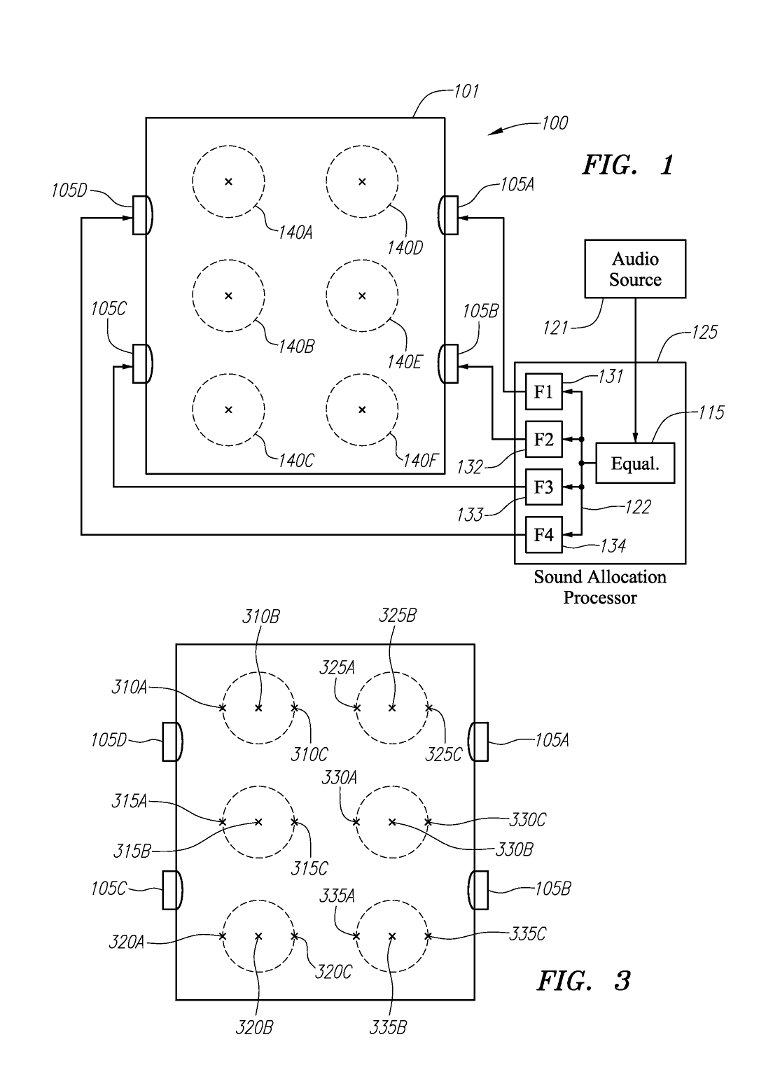

FIG. 1 shows an embodiment of a sound allocation system 100 in accordance with one aspect of the instant disclosure. In FIG. 1, an audio source 121 provides an audio signal 122 to an audio sound allocation processor 125 which, as explained in more detail below, individually modifies the sound for each of a plurality of speakers in a bounded or enclosed listening area 101. The audio source 121 may include or be derived from any source of audio content, such as, for example, a conventional radio (including FM, AM or satellite radio), a CD player, an MP3 player or source, a DVD soundtrack, or any other source of audio content. The audio source 121 may also include other audio components, such as amplifiers or pre-amplifiers, equalizers, filters, and the like.

As further illustrated in FIG. 1, a set of speakers 105A-105D (which, in this example, are four in number, although the invention may be practiced with any number of two or more speakers or other acoustic output sources), which may be monopole or dipole sources or a combination thereof, are spaced about the bounded or enclosed area 101. While in this example the speakers 105A-105D are spaced symmetrically around the bounded area 101, this configuration is not a requirement. An audio input signal 102 is supplied to an audio sound allocation processor 125 which, as described in more detail hereafter, provides individualized modifications to the phase and/or amplitude of the audio input signal 102 in order to provide more balanced and even sound at selected listening positions, or else to provide a sound field of a particular shape or characteristics over a selected range or band of frequencies. The audio sound allocation processor 125 includes audio modifying elements 131-134 which adjust the phase and/or amplitude of audio input signal 102 respectively for each of speakers 105A-105D, which are fed by audio signals 107A-107D, respectively, output by audio modifying elements 131-134. The nature of audio modifying elements 131-134 is discussed by way of illustrative examples below.

According to one embodiment that may be implemented in accordance with the example shown in FIG. 1, the audio sound allocation processor 125 modifies the phase and/or amplitude of the complex spectra associated with the audio speaker outputs in order to achieve a substantially uniform audio level at the various listening positions, or a sound field variability pattern of desired properties, while seeking to maximize total audio output. In this example, the audio sound allocation processor 125 is configured to provide a substantially uniform audio level or sound field pattern at six primary listening positions 140A-140F, although any number of listening positions may be selected.

According to another embodiment that may be implemented in accordance with the example shown in FIG. 1, the audio sound allocation processor 125 modifies the phase and/or amplitude of the complex spectra associated with the audio speaker outputs in order to reallocate or readjust the sound levels across different frequencies within a bounded or semi-bounded listening space 101. In this embodiment, the audio sound allocation processor 125 may provide different sound experiences at different listening positions; for example, it may be employed to create a “hole” or “dead zone”, i.e., a zone of relative quiet, in the overall sound field at the location of one or more of the primary listening positions 140A-140F. This type of operation can be advantageous, for example, where one or more of the listeners do not want to hear the audio content.

In either embodiment, the audio modifications described herein may be provided on an ongoing basis, or may be applied dynamically for particular situations.

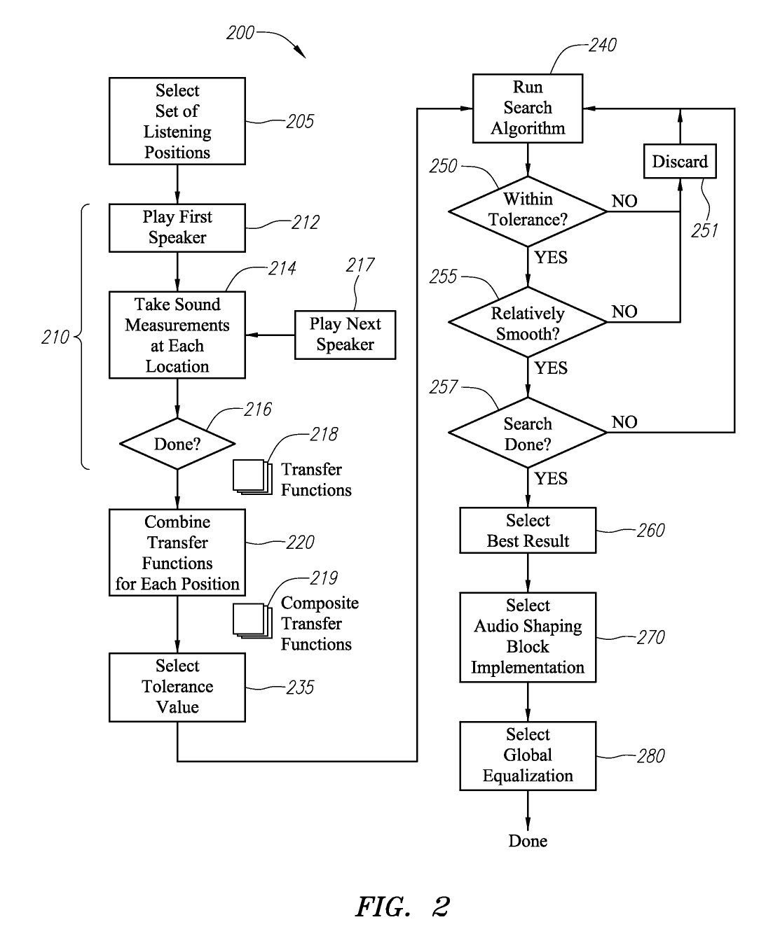

An illustration of one technique for sound level allocation is illustrated in the flow diagram 200 of FIG. 2, which may be explained by way of example with reference to the audio system 100 illustrated in FIG. 1 which, in this case, includes four speakers 105A-105D although, as noted earlier, the process may work with any arbitrary number of speakers of sufficient quantity to suitably effect the listening area. As shown in FIG. 2, the process 200 begins with a first step of selecting a set of listening positions within an enclosed or bounded listening space (e.g., area 101 shown in FIG. 1), as represented by block 205 in FIG. 2. By way of example, the six listening positions 140A-140F may be selected. While in this example, six listening positions 140A-140F are selected, any number of listening positions may be chosen. Next, sound measurements are taken in order to characterize the unmodified sound field in the absence of audio processing as described herein. These sound measurements may involve obtaining a spectral profile of the speaker output at each measurement location, characterized in the form of a complex transfer function, using any of the well-known methods for measuring the complex transfer function between a sound source and receiver. The sound measurements may be taken for each speaker independently, and may be made at only the listening positions or else at other locations in the listening area as well, as illustrated in FIG. 3 for example (measurements taken at locations 310A-C, 315A-C, 320A-C, 325A-C, 330A-C, and 335A-C).

Once the sound measurements have been taken for each speaker 105A-105D in the current example (i.e., with the sound measurement pattern of FIG. 3), the sound measurements at a given listening position or other sound measurement point are summed vectorially for each of the sound measurement points, preferably characterized in the form of a composite transfer function at each sound measurement point

Next, as illustrated in the following steps in FIG. 2, a sound allocation algorithm is run on the composite sound profiles 219 in order to generate parameters to be used with audio electronic equipment in order to create a modified sound field or sound level pattern following certain desired characteristics. In this example, as an initial aspect of the sound allocation algorithm (as indicated by step 235), a tolerance value may be selected (in terms of dB, percent, or other value) by which the sound levels at the various listening positions or other sound measurement locations may be compared. The selected tolerance value will affect how many candidate solutions are generated, and is preferably set so that a meaningful set of candidate solutions is obtained.

In a next step 240, a search is run in order to identify a candidate set of solutions to achieve a desired sound level allocation over a given range of frequencies. The desired sound level pattern may be one, for example, that is as even or uniform as possible across the different listening positions. Alternatively, the desired sound level pattern or sound field variability pattern may be one in which certain listening positions have a drop off in sound level or are substantially quiet. A multivariate algorithm may employed to select different phase and/or amplitude adjustment values for each speaker 105A-105D, using the composite transfer functions to determine the predicted output at each listening position or sound measurement location. If too many candidate solutions are obtained during the process, then the tolerance value may be tightened in order to reduce the number of possible solutions.

A candidate solution may be tested to determine whether the modified sound level pattern is relatively even across the different listening positions, i.e., the predicted sound output is within the selected tolerance across the different listening positions (assuming the goal is to make the sound levels even across the listening area) over the desired frequency range, as indicated by step 250. The smoothness or uniformity of the sound field, either globally or within a selected sound zone, may be evaluated by, e.g., looking at the standard deviation of the combined sound output at each of the listening positions or sound measurement points. The process compares the predicted sound output at each of the different listening positions or sound measurement points with one another to see if the sound output is within the selected tolerance. If not, then the candidate solution is discarded (step 251). Otherwise, the candidate solution is tested to see if the predicted sound output is relatively smooth over the desired frequency range, as indicated by step 255. If not, then the candidate solution may be discarded (step 251). Alternatively, steps 250 and 255 may be replaced by steps that test whether the candidate solution is one which provides a sound level pattern or sound field variability of desired shape, and those that deviate from the desired shape by more than a selected tolerance may be discarded.

If no candidate solutions are obtained by the above process, the tolerance may have been set too tight. In such a case, the tolerance may be increased and another attempt made to identify candidate solutions.

To create a “relatively quiet zone” in a particular location within the prescribed listening area, it is possible to apply an error weighting function to the measurement points in the quiet zone area in order to reduce the sound output within that zone. For example, an error weighting function may be applied in the quiet zones so that the sound produced by the collective sound sources will be suppressed by, for example, 10 dB or 20 dB within that region whilst retaining the same frequency response and seat to seat variation. In terms of running the above candidate solutions, the inverse of the weighting function, i.e., +10 dB or +20 dB, would be added to the measured values at the sound measurement points. Then, when the candidate solutions are tested to determine the predicted sound output, the actual sound output in the “relatively quiet zones” will actually be less by the value of the error weighting function.

In one embodiment, a converging algorithm may be employed to identify candidate solutions by perturbing the phase and/or amplitude individually for each of the speakers and predicting the sound output at the different sound measurement points, over the frequencies of interest, by using the measured transfer functions. In particular, an annealing algorithm may be employed to identify candidate solutions and converge on a best fit candidate. An annealing algorithm has the benefit of being more likely to avoid local minima and instead identify a solution that constitutes a global minimum variance. Annealing algorithms are known generally in the art and are used, for example, in aircraft for noise reduction.

As represented now in step 260, the best result from the candidate set of solutions is identified. This may be carried out as a discrete step or part of the converging algorithm that is employed to identify candidate solutions. The best candidate may be one that, through an added global equalization, may be suitable to achieve the desired pattern of sound levels and characteristics. The sound level pattern or sound field shape and structure may include desired zones of generally or substantially uniform frequency response, created in part by utilizing both destructive and constructive interference in combination. In some cases, the best result from the candidate set of solutions is one which mitigates losses through destructive interference, evens the load as much as possible on all of the speakers or other sound sources, and/or reduces peaks and dips in local zones within the target listening area or globally therein.

Assuming a suitable solution has been determined, in a next step 270, an audio modifying element implementation is selected for each speaker. Thus, in the example of FIG. 1, an implementation would be selected for audio modifying elements 131-134 that supply audio signals to speakers 105A-105D. A variety of different types of electronic components or filters may be utilized for this purpose. For example, the required equalization may be implemented by using any combination of finite response filter (FIR), infinite impulse response (IIR) filters having minimum phase or non-minimum phase, or other types of filters, in conjunction optionally with a delay element and/or a gain adjustment applicable to the particular speaker. The audio modifying elements 131-134 each apply the phase and/or amplitude adjustment that had been determined for the best solution to providing the desired sound field according to the previously run search algorithm. In certain embodiments, only amplitude adjustment may be utilized, or only phase adjustment may be utilized.

In a next step 280, a global equalization characteristic may be selected for the audio sound allocation processor 125. The global equalization collectively adjusts all of the signals fed to speakers 105A-105D so that the actual sound level pattern or sound field better matches the desired sound pattern or field. Since the sound level at each listening position is selected by the earlier process to be substantially identical within a given tolerance (assuming a sound zone or region with generally uniform or even frequency response or audio level is desired as opposed to one varying in frequency response or audio level at different listening positions), a global equalization should not change the fact that the relative sound level should remain approximately the same at each listening position. The global equalization characteristic may be implemented as a separate component within the audio sound allocation processor 125.

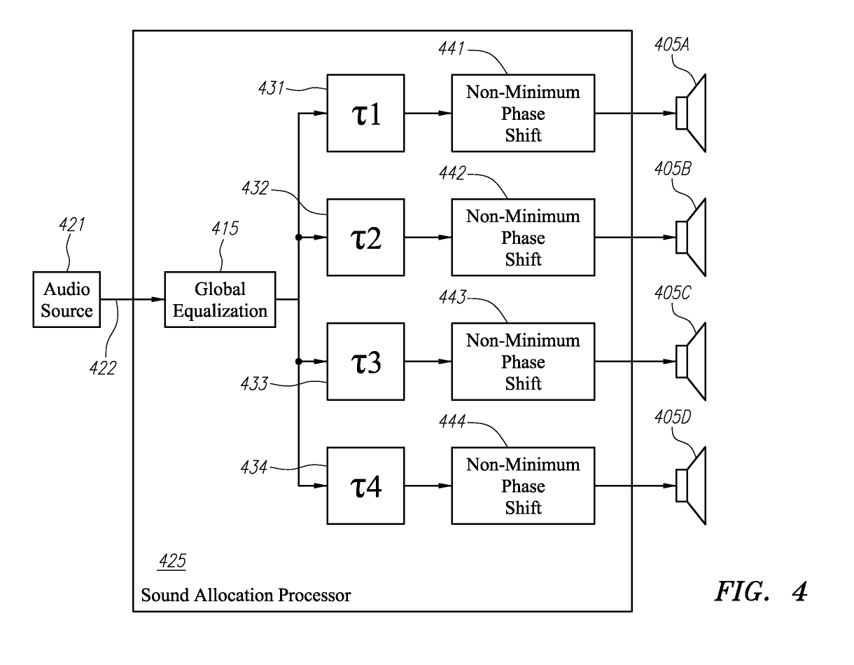

FIG. 4 illustrates a preferred implementation of a sound allocation system 400 in accordance with one embodiment as disclosed herein. Although the embodiment of FIG. 4 is similar to FIG. 1 in that it uses four speakers 404A-404D, any number of two or more speakers may be used. As illustrated in FIG. 4, the sound allocation system 400 in this example comprises an audio sound allocation processor 425 that is includes or is coupled to an audio source 421, similar to audio source 121 described previously in reference to FIG. 1. The audio source 421 provides an audio signal to an equalizer 415, which applies a global equalization to the audio signal 422 that is ultimately fed, in modified form, to each of speakers 405A-405D.

The output of the equalizer 415 is provided delay elements 431 to 434 which may apply delay adjustment that is individualized for each speaker 405A-405D. The output of the delay stages 431-434 are provided to filter stages 441-444, respectively, each of which outputs one of a set of modified audio signals 481-484 to speakers 405A-405D, respectively. Filter stages 441-444 preferably are embodied or include a non-minimum phase shift adjustment element, although they may generally comprise one or more low-pass filters, high-pass filters, bandpass filters, bandstop filters, shelf filters, non-minimum phase components, or other types of filters or elements. Filter stages 441-444 may be implemented as FIR or IIR filters, for example, or in other manners.

For purposes herein, a difference between a minimum phase shift filter and a non-minimum phase shift filter may be described as follows. A minimize phase shift filter is generally described by the transfer function:

$$\text{?} ( \text{?} ) = \frac{N \text{?}}{D ( \text{?} )}$$

$$\text{?} \text{indicates text missing or illegible when filed}$$

and which does not have zeros in the right half s plane. If, on the other hand, a filter's transfer function has zeros in the right half s plane, then it would exhibit non-minimum phase behavior. The modulus of the phase response for a non-minimum phase shift filter is larger than that for a filter with minimum phase behavior having the same amplitude response.

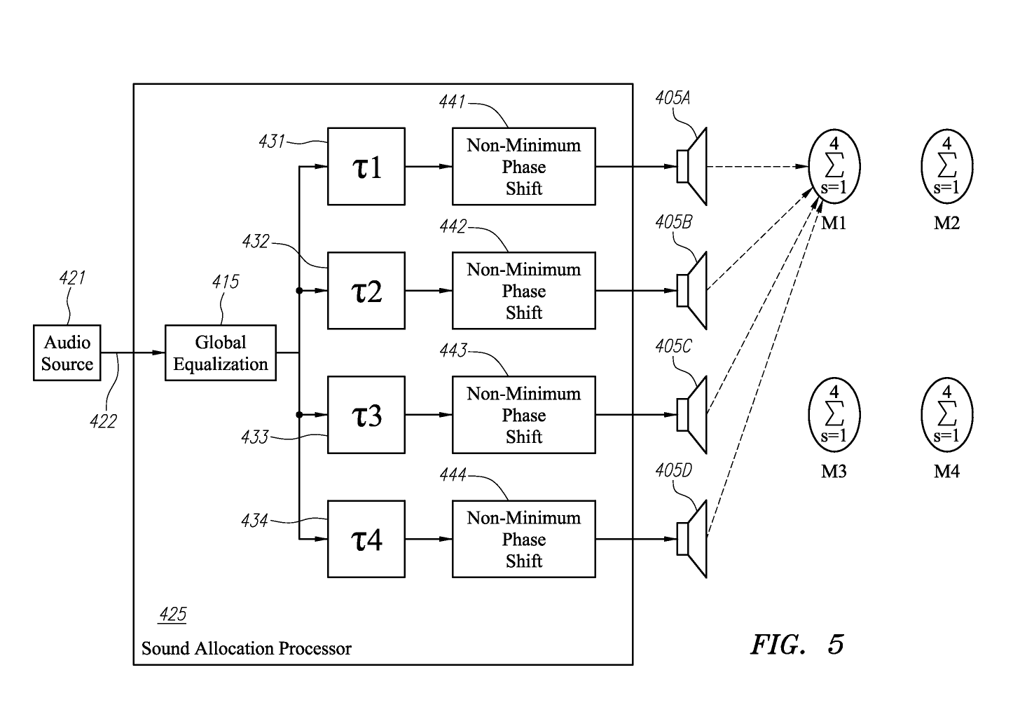

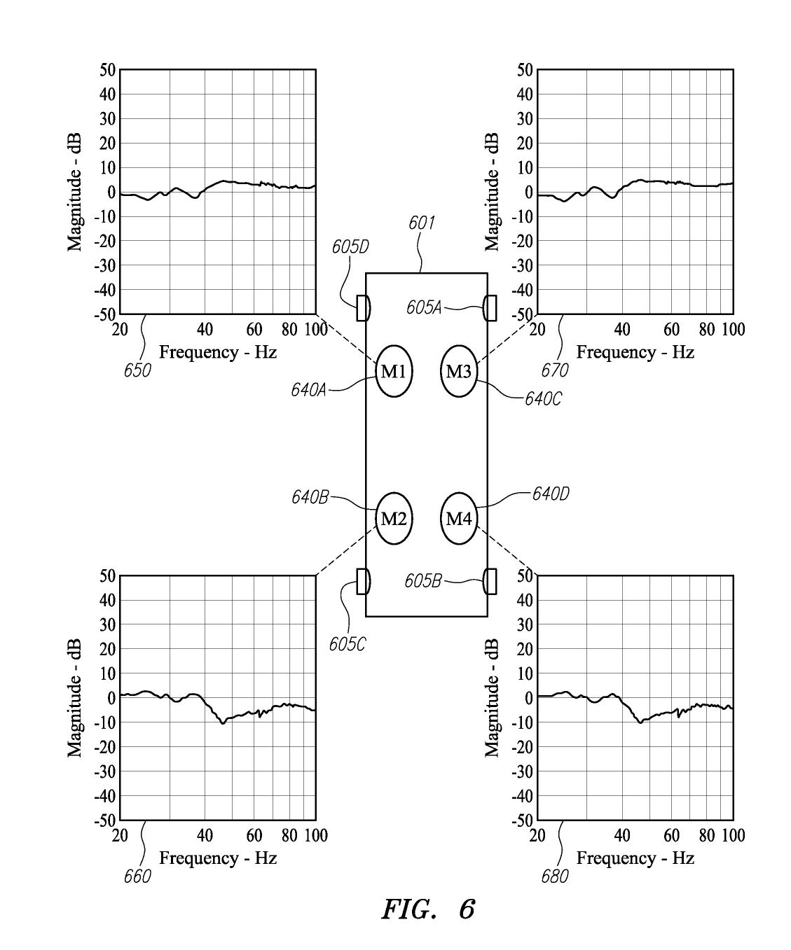

Each speaker 405A-405D receives an output from one of the filter stages 441-444, and thereby receives an audio signal that is modified in terms of phase and/or gain in order to contribute to a desired sound level pattern or sound field. FIG. 5 is a conceptual diagram showing how the aggregate modified speaker outputs combine at each listening position M1-M4 within the listening area to generate a modified sound field or frequency response at each listening position, according to one example. For example, at listening position M1, the outputs form speakers 405A-405D combine such that their aggregate outputs form a combined transfer function at listening position M1, according to the vector sum of all of the speaker outputs. A similar effect occurs at listening positions M2, M3 and M4, but in each case dependent upon the relative audio level and characteristics of each speaker output as perceived at the particular listening position.

Of course, the invention disclosed herein is not limited to the particular configuration illustrated in FIG. 4, and many other implementations are possible as would be understood by those skilled in the art.

In one or more embodiments, the speakers 105A-105D may be low frequency drive units, and the adjustments or modifications provided by the sound allocation processor may effectuate an even bass response across a plurality of listening positions.

In some cases, such as where the speakers 105A-105D are located in an automobile, the listener can make manual adjustments to the relative volume levels as amongst the speakers, for example by adjusting a fade control (which adjusts the relative volume as between front and back speakers) or a balance control (which adjusts the relative volume as between right and left speakers). Manual adjustments to the relative speaker volume levels through fade or balance controls may affect the sound allocation provided by the sound allocation processor. To adjust for the changes in relative volume, it is possible to provide different parameters for the audio modifying elements 131-134 for different levels of fade and/or balance. For example, different filter parameters may be provided at discrete fade and/or balance levels. Such parameters may be stored, for instance, in a lookup table within the sound allocation processor 125, and loaded into the audio modifying elements 131-134 in real time as the manual fade and/or balance adjustments are made. There may be one lookup table for different fade levels and one lookup table for different balance levels, or else the parameters may be combined into a single two-dimensional lookup table that uses both the fade and balance levels as selection inputs.

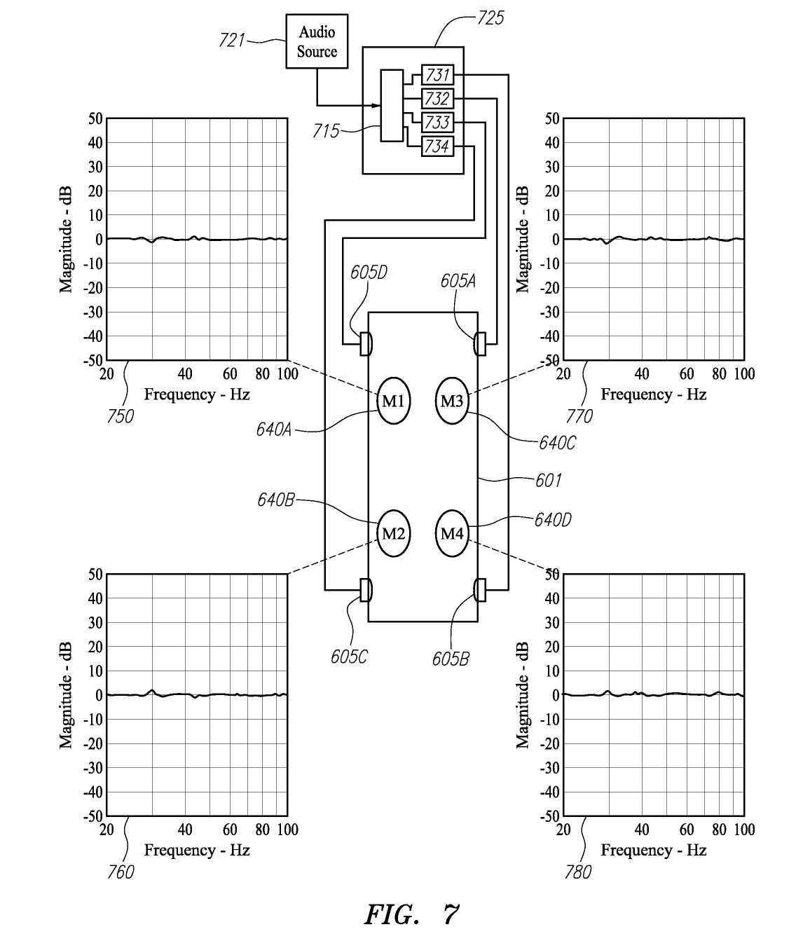

An example of a sound allocation process as applied to a particular listening area may be explained with respect to FIGS. 6 and 7. FIG. 6 shows a top view of a bounded listening area 601 with designated listening positions 640A-D (also designated as M1-M4) and speakers 605A-D at the specified locations near the corners of the listening area 601. In this example, the set of speakers 605A-D, which may be low frequency drivers or subwoofers, are located at various fixed positions in the listening area 601. All speakers 605A-D are driven equally, i.e., they each receive the same audio source signal (whether from one amplifier or multiple amplifiers). Notably, the listening positions 640A-D need not be symmetrical throughout the room, although they could be; this is a matter of design and implementation choice. Also shown in FIG. 6 are graphs 650, 660, 670 and 680 that show, for each location M1-M4, a respective frequency response curve that depicts for each location the difference in response from the mean or average response for all locations. It can be seen for example that at roughly 45 Hz, there is up to 15 dB variation in response between the four locations. This is generally undesirable from the standpoint of providing a uniform listening experience regardless of listening position.

FIG. 7 shows the same arrangement of listening area 601, speaker and listening positions, but with the speakers 605A-D driven by a sound allocation processor 725 utilizing techniques as previously described herein and, more specifically, that has been configured to apply gain and/or phase adjustments independently for each speaker over the frequency range of interest (in this case, below 100 Hertz), after employing a search algorithm or related technique to arrive at suitable parameters for the sound allocation processor 725. The sound allocation processor 725 receives an audio signal from an audio signal source 721, and then uses audio modifying components 731-734 to separately modify the spectral characteristics of the audio source signal individually for each of the speakers 605A-D, by for example adjusting a gain and/or phase of the audio source signal individually for each speaker 605A-D. As noted previously, the sound allocation processor 725 may also apply a global equalization adjustment 715 for all of the speakers 605A-D. The accompanying graphs 750, 760, 770, 780 correspond to graphs 650, 660, 670, 680 respectively in FIG. 6, and show that the deviation from the mean response is greatly reduced by the action of the sound allocation processor 725. Thus, the operation of the sound allocation processor 725 in accordance with the principles described herein may act to provide a substantially uniform sound level across different listening positions, through means of audio processing and without necessarily requiring a change in the speaker positions.

According to one or more aspects as disclosed herein, a sound allocation system comprises a plurality of speakers disposed around a bounded or semi-bounded listening area, an audio source coupled to a sound allocation processor, said sound allocation processor comprising individualized sound modification components for each speaker, wherein the sound modification components adjust the transfer function individually for each speaker to obtain a desired sound level pattern or sound field variability within the listening area, with respect to a particular frequency range or band of interest. In one or more embodiments, the sound modification components are selected so that the sound level is substantially identical, within a selected tolerance and over a desired frequency range, at each of a plurality of listening positions. In other embodiments, the sound modification components are selected so that the sound level matches a desired non-uniform sound allocation pattern over a desired frequency range across a plurality of listening positions.

In one aspect, an audio system is provided having predefined speaker locations that achieves maximum or optimal power output with minimum detectable variance (within a given tolerance) at a plurality of listening positions over a desired frequency range. In another separate aspect, an audio system is provided having predefined speaker locations that achieves maximum or optimal power output while producing a desired non-uniform sound level pattern or sound field variability in the listening area, over a desired frequency range.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

What is claimed is:

1. An audio system, comprising:
a plurality of acoustic output sources disposed in or around a bounded or semi-bounded listening area; and
a sound allocation processor receiving an audio source signal, said sound allocation processor including a plurality of audio modifying elements, one for each acoustic output source, operable to modify the audio source signal for each acoustic output source by applying at least a non-minimum phase shift adjustment tailored for each acoustic output source to create a sound field with reduced variability or a desired sound pattern over a prescribed frequency range within the listening area or defined zones within the listening area.

2. The audio system of claim 1, wherein each audio modifying element comprises one or more filters.

3. The audio system of claim 1, wherein each audio modifying element comprises a customized delay for the acoustic output source.

4. The audio system of claim 1, wherein one or more of the audio modifying elements comprises a customized gain for the acoustic output source.

5. The audio system of claim 4, further comprising a global equalization adjustment for the audio source signal.

6. The audio system of claim 2, wherein the sound allocation processor mitigates power losses caused by destructive interference of sound waves output from the acoustic output sources.

7. The audio system of claim 1, wherein said acoustic output sources include low frequency drive units.

8. The audio system of claim 1, wherein the audio modifying elements are configured to operate primarily over a low frequency range of the audio source signal.

9. The audio system of claim 1, wherein the sound allocation processor creates at least one relatively quiet zone within the listening area.

10. The audio system of claim 9, wherein the relatively quiet zone has a specified volume reduction relative to a sound volume in other parts of the listening area.

11. The audio system of claim 1, wherein the sound allocation processor creates a plurality of relatively quiet zones within the listening area.

12. The audio system of claim 1, wherein the sound allocation processor creates a zone within the listening area having a specified volume increase relative to a sound volume in other parts of the listening area.

13. A method for sound allocation in an audio system, comprising:
receiving an audio source signal;
for each of a plurality of acoustic output sources, independently modifying the audio source signal over a prescribed frequency range by applying at least a non-minimum phase shift adjustment tailored for each acoustic output source to create a sound field with reduced variability or desired sound pattern over a prescribed frequency range within the listening area or defined zones within the listening area; and
conveying the modified audio source signal to each respective acoustic output source.

14. The method of claim 13, wherein the audio source signal is modified using one or more filters customized for each acoustic output source.

15. The method of claim 13, wherein the audio source signal is modified using a delay tailored for each acoustic output source.

16. The method of claim 14, wherein the audio source signal is subject to a customized gain level for one or more of the acoustic output sources.

17. The method of claim 16, further comprising applying a global equalization adjustment to the audio source signal for all of the acoustic output sources.

18. The method of claim 13, wherein the independent modification of gain and/or phase of the audio source signal for each of the acoustic output sources mitigates power losses caused by destructive interference of sound waves output from the acoustic output sources.

19. The method of claim 13, wherein said acoustic output sources include low frequency drive units.

20. The method of claim 13, wherein the modification of gain and/or phase of the audio source signal is performed primarily over low frequencies of the audio source signal.

21. The method of claim 13, wherein the independent modification of gain and/or phase of the audio source signal for each of the acoustic output sources results in creation of at least one relatively quiet zone within the listening area.

22. The method of claim 21, wherein the relatively quiet zone has a specified volume reduction relative to a sound volume in other parts of the listening area.

23. The method of claim 13, wherein the independent modification of gain and/or phase of the audio source signal for each of the acoustic output sources results in creation of a plurality of relatively quiet zones within the listening area.

24. The method of claim 13, wherein the independent modification of gain and/or phase of the audio source signal for each of the acoustic output sources results in creation of a zone within the listening area having a specified volume increase relative to a sound volume in other parts of the listening area.

25. A method for sound modification in an audio system having a plurality of acoustic output sources in or around a prescribed listening area, comprising:
characterizing a sound transfer function for each of the acoustic output sources;
employing an annealing algorithm to identify parameters providing a specified sound level variance at defined listening positions within the listening area over a prescribed frequency range; and
durably storing the identified parameters in the audio system for future use.

26. The method of claim 25, further comprising utilizing the identified parameters in the audio system to modify an audio source signal and achieve the specified sound level variance within the listening area.

27. The method of claim 26, wherein the identified parameters are applied to adjust a gain and/or a phase of the audio source signal independently for each of the acoustic output sources.

28. The method of claim 27, further comprising using one or more custom filters for each acoustic output source to independently modify the audio source signal for that acoustic output source.

29. The method of claim 25, wherein the annealing algorithm includes:
selecting candidate sound modification parameters for each acoustic output sources;
applying the sound modification parameters to determine a sound output level at the defined listening positions within the listening area; and
determining a variance in sound output level between the different listening positions.

30. The method of claim 29, further comprising determining whether the variance in sound output is within a specified tolerance.

31. The method of claim 29, wherein the sound modification parameters include a custom gain associated with each acoustic output source.

32. The method of claim 29, wherein the sound modification parameters include a custom delay and non-minimum phase shift associated with each acoustic output source.

33. An audio system, comprising:
a plurality of acoustic output sources disposed in or around a listening area; and
a sound allocation processor receiving an audio source signal, said sound allocation processor including a plurality of audio modifying elements, one for each acoustic output source, applying at least a non-minimum phase shift of the audio source signal for each acoustic output source over a prescribed frequency range to create zones of substantially uniform frequency response within the listening area while mitigating power losses due to destructive interference of sound waves output from the acoustic output sources.

34. The audio system of claim 33, wherein each audio modifying element comprises one or more infinite impulse response (IIR) filters.

35. The audio system of claim 34, wherein each audio modifying element comprises a delay tailored for the acoustic output source over the prescribed frequency range.

36. The audio system of claim 34, wherein one or more of the audio modifying elements comprises a dedicated gain stage tailored to the acoustic output source.

37. The audio system of claim 36, further comprising a global equalization adjustment applied to the audio source signal for all of the acoustic output sources.
